(19) United States
(12) Patent Application Publication
(10) Pub. No.: US 2017/0339219 A1
(43) Pub. Date: Nov. 23, 2017

(54) TRANSPARENT WIDE-AREA SERVICE MIGRATION WITH MPTCP

(71) Applicant: INTERNATIONAL BUSINESS MACHINES CORPORATION, ARMONK, NY (US)

(72) Inventors: THAI FRANCK LE, YORKTOWN HEIGHTS, NY (US); ERICH M. NAHUM, YORKTOWN HEIGHTS, NY (US)

(21) Appl. No.: 15/156,835

(22) Filed: May 17, 2016

(51) Int. Cl. H04L 29/08; H04L 12/707; H04L 29/06; H04L 12/46; H04L 29/12

(52) U.S. Cl. CPC H04L 67/1004; H04L 69/163; H04L 67/42; H04L 12/4633; H04L 67/143; H04L 45/24; H04L 61/6068

(57) ABSTRACT

A system for server migration includes a first computer hosting a service during a first period of time. A second computer hosts the service during a second, third and fourth period of time. A client computer communicates directly with the service at a first IP address, during the first period of time. The client computer communicates with the service at the first IP address, during the second and third periods of time, through a tunneled connection via a first subflow of a multi-path communication session. The client computer communicates directly with the service at the second IP address, during the third period of time, via a second subflow of the multi-path communication session, and discontinue the first subflow of the multi-path communication session while maintaining the second subflow of the multi-path communication session during the fourth period of time.

### GOVERNMENT LICENSE RIGHTS STATEMENT

This invention was made with Government support under Contract No. W911NF-06-3-0001 (1L) awarded by Army Research Office (ARO). The Government has certain rights in this invention.

### BACKGROUND

### 1. Technical Field

The present disclosure relates to service migration and, more specifically, to transparent wide-area service migration with MPTCP.

### 2. Discussion of Related Art

Service of hosted content is often provided by a remote computer system accessible over a wide-area network (WAN) such as the Internet. While the service of the hosted content may be executed directly on the host computer system, more often, service is provided by virtual machines (VMs) or Containers that are themselves executed on host computer systems.

While the tendency is for the host computer systems to remain at a fixed location, such as a particular data center, and for the VMs and containers running thereon to remain running on the same host computer systems or others at the same data center, it happens from time to time that a need arises to migrate the hosted services to a new data center at a new location.

Migrating a service between physical hosts within the same data center is not problematic as the same IP address may be kept and other systems may be notified of the change by an ARP broadcast. However, while it might not be particularly difficult to get a VM or container running at a new data center, the IP address of the service at the new data center would tend to be different from the IP address of the service at the old data center.

To the extent that Domain Name System (DNS) is used to lookup an IP address from a domain name, it is possible to change the IP address associated with a domain name so that going forward, when a user enters a desired URL, new client requests such as TCP traffic is sent to the new IP address. However, not all TCP traffic is initiated with the entering of a domain name, and thus DNS is not always consulted in establishing a new connection. Moreover, it is very common today for connections to be maintained for long periods of time, and even indefinitely. Many of these connections are critical to the operation of enterprises, as more and more essential services are cloud-based. Thus it may be difficult to migrate a service for which active connections need to be maintained.

### BRIEF SUMMARY

A system for server migration includes a first computer system, disposed in a first data center, for hosting a service during a first period of time. A second computer system is disposed in a second data center geographically isolated from the first data center, for hosting the service during a second, third and fourth period of time. The second period of time follows the first period of time, the third period of time follows the second period of time, and the fourth period of time follows the third period of time. One or more client computer systems communicate directly with the service at a first IP address, during the first period of time, communicate with the service at the first IP address, during the second and third periods of time, through a tunneled connection between the first data center and the second data center, via a first subflow of a multi-path communication session, communicate directly with the service at the second IP address, during the third period of time, via a second subflow of the multi-path communication session, and discontinue the first subflow of the multi-path communication session while maintaining the second subflow of the multi-path communication session during the fourth period of time.

The first computer system, the second computer system and the one or more client computer systems may each implement Multipath Transmission Control Protocol (MPTCP) and the first and second subflows of the multi-path communication session may be established pursuant to MPTCP.

The second subflow may be established in the third period of time using an Add Address command, adding the second IP address to the multi-path communication session, and the first subflow may be discontinued in the fourth period of time using a Remove Address command, removing the first IP address from the multi-path communication session.

The service may be instantiated on the first computer system as a Virtual Machine during the first period of time and the Virtual Machine may be migrated from the first computer system to the second computer system in the second period of time.

The service may alternatively be instantiated on the first computer system as a container during the first period of time and the container may be migrated from the first computer system to the second computer system in the second period of time.

The one or more client computer systems may have a first client IP address and a second client IP address, and the client may communicate between the first client IP address and the first IP address of the service, through the tunnel, via the first subflow. The client may communicate between the second client IP address and the first IP address of the service, through the tunnel, via a third subflow. The client may communicate between the first client IP address and the second IP address of the server, directly, via the second subflow. The client may communicate between the second client IP address and the second IP address of the server, directly, via a fourth subflow.

A method for migrating a server includes hosting a service on a first computer system disposed at a first location. A communication session is initiated between a client computer and the service at a first IP address. The service is migrated from the first computer system to a second computer system disposed at a second location that is remote with respect to the first location, while maintaining the communication session. The communication session is continued by tunneling communications between the client computer and the first computer system to the service at second computer system via a wide area network. The tunneled communications represent a first subflow of the communication session. A second subflow of the communication session is established by opening direct communications between the client computer and the service at the second computer system, while the first subflow is maintained. The first subflow is discontinued while the second subflow is maintained.

The first computer system, the second computer system and the client computer system may each implement Multipath Transmission Control Protocol (MPTCP) and the first and second subflows of the communication session may be established pursuant to MPTCP.

Establishing the second subflow of the communication session may include issuing an Add Address command, by the first computer system, to add the IP address of the second computer system to the communication session, and issuing a Join Connection command, by the client computer.

Discontinuing the first subflow of the communication session may include issuing a Remove Address command, by the second computer system, to remove the IP address of the first computer system from the communication session.

The service may be instantiated on the first computer system as a Virtual Machine and migrating the service from the first computer system to the second computer system may include transmitting the Virtual Machine from the first computer system to the second computer system and executing the Virtual Machine on a hypervisor running on the second computer system.

The service may be instantiated on the first computer system as a container and migrating the service from the first computer system to the second computer system may include transmitting the container from the first computer system to the second computer system and executing the container on the second computer system.

The first computer system and the second computer system may be disposed within distinct subnets.

A computer system includes a processor and a non-transitory, tangible, program storage medium, readable by the computer system, embodying a program of instructions executable by the processor to perform method steps for migrating a server. The method includes hosting a service on a first computer system disposed at a first location. A communication session is initiated between a client computer and the service at a first IP address. The service is migrated from the first computer system to a second computer system disposed at a second location that is remote with respect to the first location, while maintaining the communication session. The communication session is continued by tunneling communications between the client computer and the first computer system to the service at second computer system via a wide area network. The tunneled communications represent a first subflow of the communication session. A second subflow of the communication session is established by opening direct communications between the client computer and the service at the second computer system, while the first subflow is maintained. The first subflow is discontinued while maintaining the second subflow.

The first computer system, the second computer system and the client computer system may each implement Multipath Transmission Control Protocol (MPTCP) and the first and second subflows of the communication session may be established pursuant to MPTCP.

Establishing the second subflow of the communication session may include issuing an Add Address command, by the first computer system, to add the IP address of the second computer system to the communication session, and issuing a Join Connection command, by the client computer.

Discontinuing the first subflow of the communication session may include issuing a Remove Address command, by the second computer system, to remove the IP address of the first computer system from the communication session.

The service may be instantiated on the first computer system as a Virtual Machine and migrating the service from the first computer system to the second computer system may include transmitting the Virtual Machine from the first computer system to the second computer system and executing the Virtual Machine on a hypervisor running on the second computer system.

The service may alternatively be instantiated on the first computer system as a container and migrating the service from the first computer system to the second computer system may include transmitting the container from the first computer system to the second computer system and executing the container on the second computer system.

The first computer system and the second computer system may be disposed within distinct subnets.

### BRIEF DESCRIPTION OF THE SEVERAL VIEWS OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a server environment for local migration in accordance with exemplary embodiments of the present invention;

FIG. 2 is a schematic diagram illustrating a server environment prior to remote migration in accordance with exemplary embodiments of the present invention;

FIG. 3 is a schematic diagram illustrating a server environment after remote migration in accordance with exemplary embodiments of the present invention;

FIG. 4 is a schematic diagram illustrating an optimized server environment after remote migration in accordance with exemplary embodiments of the present invention;

FIG. 5 is a schematic diagram illustrating a server environment for remote migration using MPTCP in accordance with exemplary embodiments of the present invention;

FIG. 6 is a flow chart illustrating an approach for remote migration using MPTCP in accordance with exemplary embodiments of the present invention; and

FIG. 7 shows an example of a computer system capable of implementing the method and apparatus according to embodiments of the present disclosure.

### DETAILED DESCRIPTION

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to provide a system and method for the migration of services between distinct data centers and other migrations that result in a change of IP addresses for the service while maintaining open connections between the host being migrated and one or more clients accessing the service.

There are many reasons for wishing to migrate a server to another data center. For example, a server might have scheduled downtime and a backup server might be located in a different data center. Also, it may be desirable to relocate a server to be closer to its users or closer to a particular ISP. Regardless of the reason for wishing to migrate the server, it may be desirable to maintain live connections while the migration process is performed to provide uninterrupted service to all clients.

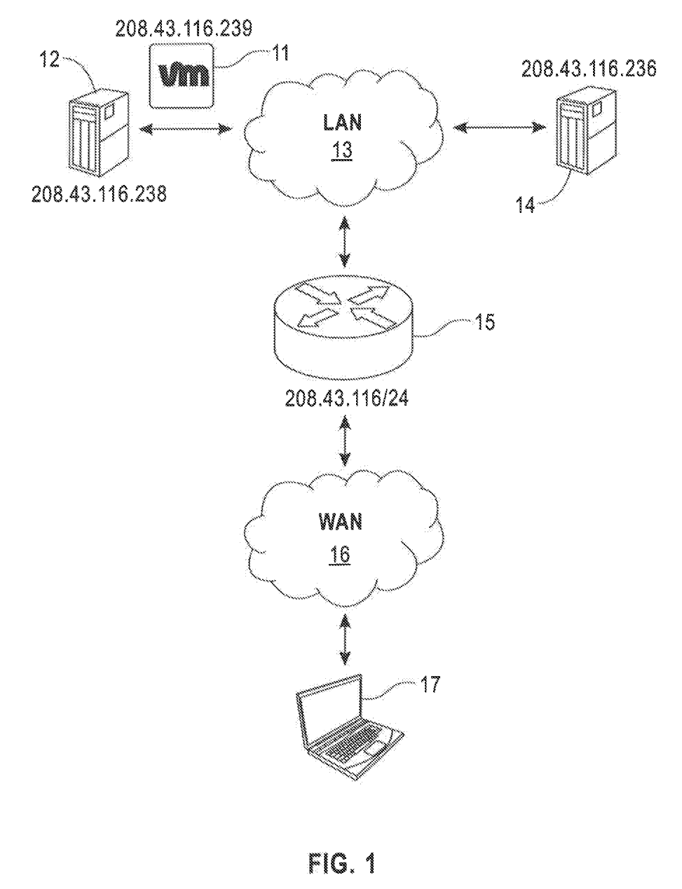

FIG. 1 is a schematic diagram illustrating a server environment for local migration in accordance with exemplary embodiments of the present invention. As can be seen from this figure, a virtual machine 11 is provided on a first physical machine 12. The virtual machine (VM) may have an IP address that is within a particular subnet. The first physical machine 12 may have an IP address within the same subnet. A client 17 may access the VM 11 over a wide area network (WAN) 16. The first physical machine 12 and the VM 11 may be connected to the WAN 16 through a local area network (LAN) 13 and a gateway router 15.

In migrating the VM 11 from the first physical machine 12 to a second physical machine 14 that is part of the same subnet, e.g. connected via the same LAN 13, the IP address of the VM 11 may stay the same and service need not be interrupted during the migration. However, assuring vitality of connections becomes more complicated when migrating to a physical machine that is located in a different data center having a different subnet address.

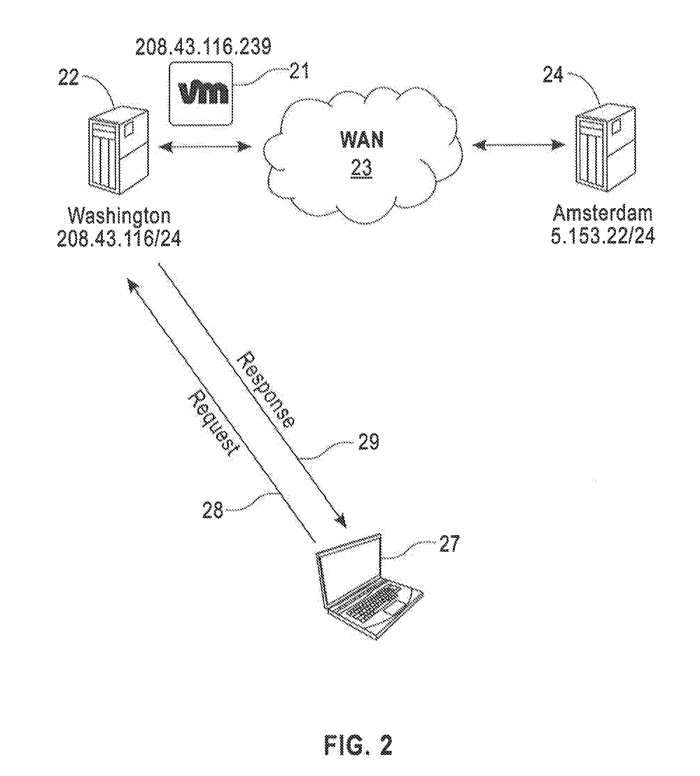

FIGS. 2-5 are schematic diagrams illustrating a server environment for remote migration in accordance with exemplary embodiments of the present invention. As can be seen from FIG. 1, a VM 21 providing a service is running on a first physical machine 22 located at a first geographic location, here identified as Washington. A client communicates with the VM 21 by sending requests 28 directly to the first physical machine 22. Responses are sent by the VM 21 from the first physical machine 22 directly to the client 27. However, here the second physical machine 24, which the VM 21 is to be migrated to, is located at a second geographic location, here identified as Amsterdam. The VM 21 has an IP address within the same subnet as that of the first physical machine 22, but the VM 21 has an IP address within a different subnet as that of the second physical machine 24. The first physical machine 22 and the second physical machine 24 might only be able to communicate with each other over a WAN 23.

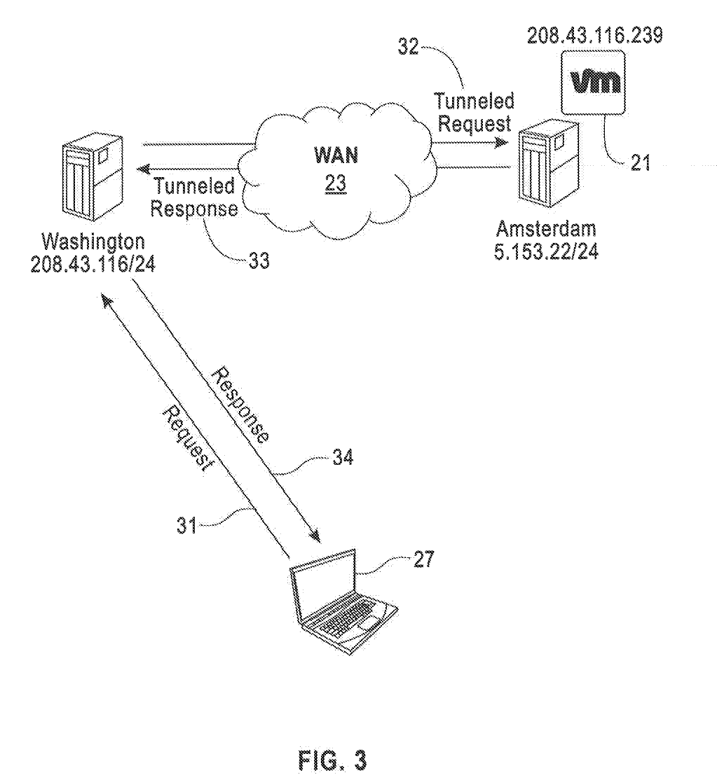

As can be seen from FIG. 3, one way in which open connections may be preserved when migrating the VM 21 from the first physical machine to the second physical machine, is to tunnel the requests and responses between the two physical machines through the WAN. For example, the client may send requests 31 directly to the first physical machine at its IP address and the first physical machine may send a tunneled request to the VM 21, now running on the second physical machine at a different IP address. Tunneled responses may be sent from the VM on the second physical machine to the first physical machine through the WAN. The first physical machine may then send responses 34 directly to the client. In this way, the IP address of the VM may remain the same, as the requests and responses may be tunneled through the WAN, for example, as part of a virtual private network (VPN).

However, the above approach is not without disadvantages. For example, the first physical machine, or at the very least, a device located within the subnet of the first physical machine, must remain active to handle the tunneling and direct communications. This may be a problem if the reason for the migration was to decommission the original data center. Moreover, total network traffic is greatly expanded by the presence of the tunneled requests 32 and responses 33 as packets would need to traverse the tunnel twice. This may add to the cost of providing the service, as additional bandwidth is consumed, and may also slow down the speed of the communication between client and service by adding delays which may be on the order of hundreds of milliseconds. Additionally, as the total route is made longer, the possibility of packet loss is increased, thereby delaying the communication further. Additionally, tunneling may require adding an additional header to each packet transmitted, thereby increasing packet overhead. Where packets are already at the maximum size for transmission, the additional header might make the packet larger than the maximum transmission unit (MTU), thereby causing packets to be dropped or fragmented.

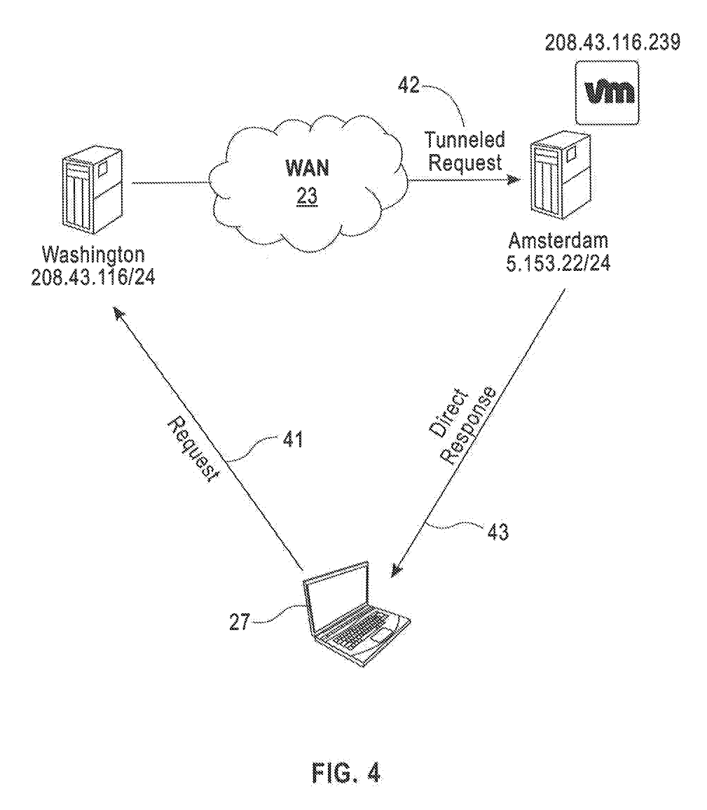

The approach discussed above with respect to FIG. 3 can be optimized by sending the responses directly from the VM at the second physical machine to the client. FIG. 4 is a schematic diagram illustrating an optimized approach for server migration in accordance with exemplary embodiments of the present invention. As can be seen from this figure, the client may send requests to the IP address of the first physical machine and then tunneled requests 42 may be sent from the first physical machine to the VM running on the second physical machine. However, rather than tunneling the responses, the VM at the second physical machine may be optimized to send responses 43 directly to the client. Some of the problems associated with the approach illustrated in FIG. 3 may be mitigated, but not eliminated.

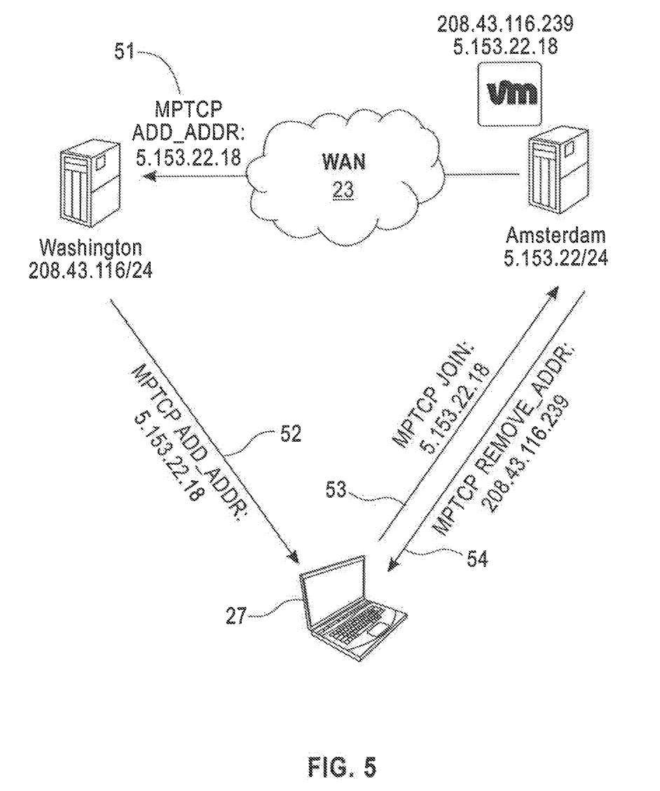

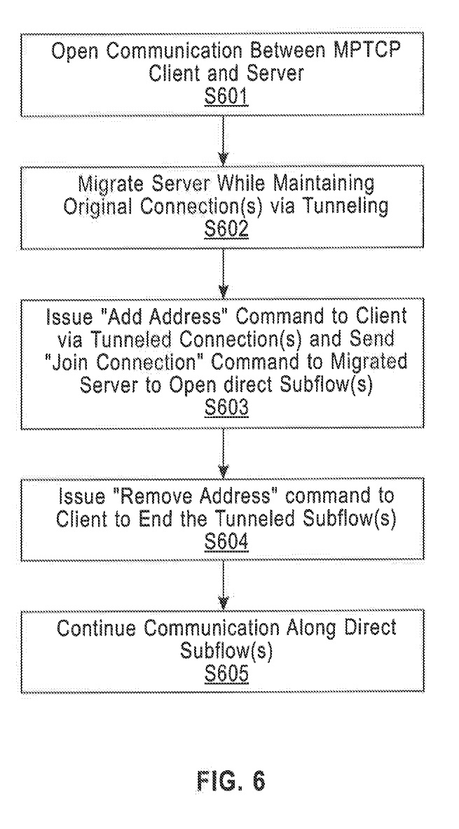

To solve the problems discussed above, exemplary embodiments of the present invention may utilize multi-path TCP (MPTCP) to implement the migration of the VM from the first physical machine to the second physical machine, which is located remotely with respect to the first physical machine, while maintaining active communication sessions between clients and the migrating server, and without having to tunnel, or otherwise forward requests and responses between the locations of the two physical machines. FIG. 5 is a schematic diagram illustrating a server configuration for MPTCP service migration according to exemplary embodiments of the present invention and FIG. 6 is a flow chart illustrating an approach for MPTCP service migration according to exemplary embodiments of the present invention.

MPTCP is a set of protocols developed to permit simultaneous TCP connections between two machines along multiple different paths. By permitting simultaneous connections along different paths, MPTCP seeks to provide more efficient utilization of available routes which may make communications more robust and faster. For example, MPTCP may be used to allow a smartphone to communicate with a server over Wi-Fi and a mobile network, simultaneously, so that data may be exchanged faster and with greater resiliency.

During the normal implementation of MPTCP, for example, in the case of the smartphone with a Wi-Fi connection and a mobile network connection, it is understood that the smartphone is in one location and yet the smartphone has two distinct IP addresses, one IP address is assigned by the user's broadband ISP and is used in transmitting packets via Wi-Fi, and another IP address is assigned by the user's cellular service provider and is used in transmitting packets via the mobile network. In this case, the communication is initiated using one IP address of the smartphone, for example, the IP address assigned by the broadband ISP, and then a second path is created between the server and the smartphone by adding the IP address of the smartphone assigned by the cellular service provider.

Exemplary embodiments of the present invention may utilize the capabilities of MPTCP to implement server migration. This process may begin by opening communication between a client 27 and service 21 that both support MPTCP (Step S601). The service 21 may then be migrated from the first physical machine 22 at the first geographic location (e.g. Washington) to the second physical machine 24 at the second geographic location (e.g. Amsterdam) (Step S602). Migration of the service may be performed, for example, by copying the VM or container, transmitting the VM/Container to the new host machine 24, and then running the VM/container on the new host machine 24.

The connection between the client and server is maintained, during server migration, using the tunneling approach disclosed above (Step S602). The server 21, now running on the second physical machine 24, may then issue an “add address” command “ADD_ADDR” to add the new IP address of the VM 21 to the multi-path TCP connection. The add address command 51 may be tunneled through the WAN 23 to the first physical machine 22, or some other device located within its subnet to then sent directly (52) from the first physical machine 22 to the client 27 (Step S603). Upon receiving the add address command, a second path is opened directly between the client 27 and the VM 21 running on the second physical machine 24 as the client initiates a new subflow in accordance with the add address command. This is performed by the client sending a “join connection” command “MP_JOIN” or “ADDR_JOIN” to the service, directly, at the new IP address (53).

While the service 21, at the second physical machine 24 could initiate a connection directly with the client 27 without relying upon the MPTCP commands, in practice this approach may fail where the client 27 is behind a NAT or a Firewall device. Accordingly, exemplary embodiments of the present invention may utilize the MPTCP commands to establish the connection directly between the service 21 at the second physical machine 24 and the client 27 as a second subflow, for example, as described above.

At this stage, the client and VM are now in communication with each other along two paths: The first path is a tunneled path from client and the original IP address of the server that goes through the first physical machine, and the second path is direct, between the client and the new IP address of the server.

After the second subflow is established, and there are two simultaneous paths of communication between client and server, the server may close the tunneled subflow by issuing a “Remove Address” command “REMOVE_ADDR” to the client (54) (Step S604). While the Remove Address command is shown as passing along the direct connection subflow, in actuality, as there are two simultaneous paths of communication open between client and server, the Remove Address command could pass along either subflow. As a result, communication, (e.g. passing of requests and responses) may be continued exclusively along the direct subflow (Step S605).

It is to be understood that as the use of MPTCP may allow for multiple subflows, prior to migration there may already be multiple subflows established between the client and the server. For example, there may be a first subflow established between the client and the server via the client's Wi-Fi, using a first IP address of the client and there may be a second subflow established between the client and the server via the client's wireless service connection, using a second IP address of the client. Where such a connection is already in place, the above-described approach for server migration may be adapted so as to add the new subflow while the first two subflows are tunneled, and then to cancel each of the first two subflows after the new subflow is created. Additionally, rather than establishing only one new subflow, two new direct subflows may be established prior to closing the original two subflows, that are tunneled. Thus exemplary embodiments of the present invention may be performed regardless of how many subflows are in place prior to migration.

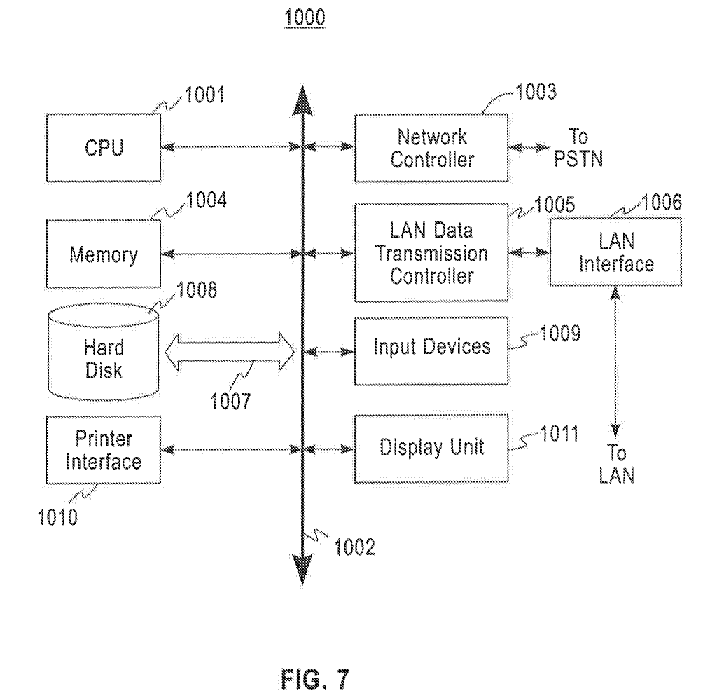

FIG. 7 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A system for server migration, comprising:
a first computer system, disposed in a first data center, for hosting a service during a first period of time;
a second computer system, disposed in a second data center geographically isolated from the first data center, for hosting the service during a second, third and fourth period of time, wherein the second period of time follows the first period of time, the third period of time follows the second period of time, and the fourth period of time follows the third period of time; and
one or more client computer systems for:
communicating directly with the service at a first IP address, during the first period of time;
communicating with the service at the first IP address, during the second and third periods of time, through a tunneled connection between the first data center and the second data center, via a first subflow of a multi-path communication session;
communicating directly with the service at the second IP address, during the third period of time, via a second subflow of the multi-path communication session; and
discontinuing the first subflow of the multi-path communication session while maintaining the second subflow of the multi-path communication session during the fourth period of time.

2. The system of claim 1, wherein the first computer system, the second computer system and the one or more client computer systems each implement Multipath Transmission Control Protocol (MPTCP) and the first and second subflows of the multi-path communication session are established pursuant to MPTCP.

3. The system of claim 2, wherein the second subflow is established in the third period of time using an Add Address command, adding the second IP address to the multi-path communication session, and the first subflow is discontinued in the fourth period of time using a Remove Address command, removing the first IP address from the multi-path communication session.

4. The system of claim 1, wherein the service is instantiated on the first computer system as a Virtual Machine during the first period of time and the Virtual Machine is migrated from the first computer system to the second computer system in the second period of time.

5. The system of claim 1, wherein the service is instantiated on the first computer system as a container during the first period of time and the container is migrated from the first computer system to the second computer system in the second period of time.

6. The system of claim 1, wherein the one or more client computer systems have a first client IP address and a second client IP address, and the client communicates between the first client IP address and the first IP address of the service, through the tunnel, via the first subflow, the client communicates between the second client IP address and the first IP address of the service, through the tunnel, via a third subflow, the client communicates between the first client IP address and the second IP address of the server, directly, via the second subflow, and the client communicates between the second client IP address and the second IP address of the server, directly, via a fourth subflow.

7. A method for migrating a server, comprising:
hosting a service on a first computer system disposed at a first location;
initiating a communication session between a client computer and the service at a first IP address;
migrating the service from the first computer system to a second computer system disposed at a second location that is remote with respect to the first location, while maintaining the communication session;
continuing the communication session by tunneling communications between the client computer and the first computer system to the service at second computer system via a wide area network, wherein the tunneled communications represent a first subflow of the communication session;
establishing a second subflow of the communication session by opening direct communications between the client computer and the service at the second computer system, while the first subflow is maintained; and
discontinuing the first subflow while maintaining the second subflow.

8. The method of claim 7, wherein the first computer system, the second computer system and the client computer system each implement Multipath Transmission Control Protocol (MPTCP) and the first and second subflows of the communication session are established pursuant to MPTCP.

9. The method of claim 7, wherein establishing the second subflow of the communication session includes issuing an Add Address command, by the first computer system, to add the IP address of the second computer system to the communication session, and issuing a Join Connection command, by the client computer.

10. The method of claim 7, wherein discontinuing the first subflow of the communication session includes issuing a Remove Address command, by the second computer system, to remove the IP address of the first computer system from the communication session.

11. The method of claim 7, wherein the service is instantiated on the first computer system as a Virtual Machine and migrating the service from the first computer system to the second computer system includes transmitting the Virtual Machine from the first computer system to the second computer system and executing the Virtual Machine on a hypervisor running on the second computer system.

12. The method of claim 7, wherein the service is instantiated on the first computer system as a container and migrating the service from the first computer system to the second computer system includes transmitting the container from the first computer system to the second computer system and executing the container on the second computer system.

13. The method of claim 7, wherein the first computer system and the second computer system are disposed within distinct subnets.

14. A computer system comprising:
a processor; and
a non-transitory, tangible, program storage medium, readable by the computer system, embodying a program of instructions executable by the processor to perform method steps for migrating a server, the method comprising:
hosting a service on a first computer system disposed at a first location;
initiating a communication session between a client computer and the service at a first IP address;
migrating the service from the first computer system to a second computer system disposed at a second location that is remote with respect to the first location, while maintaining the communication session;
continuing the communication session by tunneling communications between the client computer and the first computer system to the service at second computer system via a wide area network, wherein the tunneled communications represent a first subflow of the communication session;
establishing a second subflow of the communication session by opening direct communications between the client computer and the service at the second computer system, while the first subflow is maintained; and
discontinuing the first subflow while maintaining the second subflow.

15. The computer system of claim 14, wherein the first computer system, the second computer system and the client computer system each implement Multipath Transmission Control Protocol (MPTCP) and the first and second subflows of the communication session are established pursuant to MPTCP.

16. The computer system of claim 14, wherein establishing the second subflow of the communication session includes issuing an Add Address command, by the first computer system, to add the IP address of the second computer system to the communication session, and issuing a Join Connection command, by the client computer.

17. The computer system of claim 14, wherein discontinuing the first subflow of the communication session includes issuing a Remove Address command, by the second computer system, to remove the IP address of the first computer system from the communication session.

18. The computer system of claim 14, wherein the service is instantiated on the first computer system as a Virtual Machine and migrating the service from the first computer system to the second computer system includes transmitting the Virtual Machine from the first computer system to the second computer system and executing the Virtual Machine on a hypervisor running on the second computer system.

19. The computer system of claim 14, wherein the service is instantiated on the first computer system as a container and migrating the service from the first computer system to the second computer system includes transmitting the container from the first computer system to the second computer system and executing the container on the second computer system.

20. The computer system of claim 14, wherein the first computer system and the second computer system are disposed within distinct subnets.
